(19) United States
(12) Patent Application Publication
(10) Pub. No.: US 2022/0058241 A1
(43) Pub. Date: Feb. 24, 2022

(54) SYSTEM AND METHOD FOR ASSOCIATING INFORMATION WITH A DIGITAL IMAGE FILE USING A DIGITAL LEDGER

(71) Applicant: Sony Corporation, Tokyo (JP)

(72) Inventors: Björn Ekberg, Lund (SE); Jörgen Ekström, Lund (SE)

(21) Appl. No.: 16/754,813

(22) PCT Filed: Nov. 28, 2017
(86) PCT No.: PCT/US2017/063500

§ 371 Date: Apr. 9, 2020

(51) Int. Cl. G06F 21/10; H04L 9/32; G06Q 20/12; H04N 5/913

(52) U.S. Cl. CPC G06F 21/10; H04L 9/3236; G06Q 20/1235; H04N 2005/91307; H04L 2209/38; H04L 2209/56; G06F 2221/0775; H04N 5/913

(57) ABSTRACT

An electronic device includes a camera assembly configured to capture an image and to process the image to create an image file. The electronic device further includes a communications interface, and a processor configured to generate digital ledger data comprising a smart contract providing rights to use or access the image based on a condition being satisfied, and image rights management information. The processor is further configured to transmit the digital ledger data using the communications interface, to a digital ledger network, and embed a pointer or link as a portion of data included within the image file. The pointer or link provides a location to access the digital ledger data.

### TECHNICAL FIELD OF THE INVENTION

The technology of the present disclosure relates generally to electronic devices that generate and transmit digital ledger data associated with an image file at creation of the image file, and electronic devices that process digital ledger data associated with an image file. Also disclosed are exemplary functions that may be carried out using image files created in the disclosed manner.

### BACKGROUND

Digital cameras are in wide-spread use. Images created by digital cameras may be easily shared among electronic devices over the Internet. Wide availability of images on the internet allows users to access these images and use them as they wish. In these circumstances, legal benefits attributed to an author or creator of an image, such as copyright, may be overlooked because the image does not include ownership, purchase, or licensing information.

Therefore, there exists a need to improve digital image files and methods of distributing digital image files to address these and other issues.

### SUMMARY

The disclosed approach to image file creation includes adding unique information to the image data at image file creation. The unique information may be in the form of a pointer or link to digital ledger data, such as blockchain data. The digital ledger data may include one or more of a hash of the image, an owner of the image's copyright, licensing and/or purchase information, a smart contract, an identifier of the camera module, a location at which the image was created, a person that took image (e.g., user of the camera), an organization or an account associated with the camera or user of the camera, or other information. A user may select the image file and provide digital ledger-based payment in return for rights to use the image. The embodiments disclosed herein provide an easy and secure method of associating information with an image file, and keeping the associated information secure.

According to one aspect of the disclosure, an electronic device includes a camera assembly configured to capture an image and to process the image to create an image file. The electronic device further includes a communications interface, and a processor configured to generate digital ledger data comprising a smart contract providing rights to use or access the image based on a condition being satisfied, and image rights management information. The processor is further configured to transmit the digital ledger data using the communications interface, to a digital ledger network, and embed a pointer or link as a portion of data included within the image file. The pointer or link provides a location to access the digital ledger data.

According to one embodiment of the electronic device, the smart contract is a portion of computer code.

According to one embodiment of the electronic device, the image rights management information includes an identifier of an owner of the image file.

According to one embodiment of the electronic device, the image rights management information includes an identifier of an account associated with an owner of the image file.

According to one embodiment of the electronic device, the image rights management information includes available rights and prices associated with a purchase of the available rights.

According to another aspect of the disclosure a method of tracking ownership information for an image includes capturing image data using a camera assembly; processing the image data to generate an image file; generating digital ledger data comprising a smart contract, and image rights management information associated with the image data; transmitting the digital ledger data to a digital ledger network; generating a pointer or a link to the digital ledger data; and embedding the pointer or the link in the image file.

According to one embodiment of the method, the method further includes receiving payment from a user based on the user purchasing a right to use the image, and satisfying a condition of the smart contract.

According to one embodiment of the method, the smart contract is a portion of code that provides rights to use the image, or access to the image, based on a receipt of payment.

According to one embodiment of the method, the image rights management information includes an identifier of an owner of the image file.

According to one embodiment of the method, the image rights management information includes an identifier of an account associated with an owner of the image file.

According to one embodiment of the method, the image rights management information includes available rights and prices associated with a purchase of the available rights.

According to another aspect of the disclosure, a method of providing a right to use an image includes obtaining, from a user, a selection of an image; providing a link or a location to where digital ledger data associated with the image may be retrieved; executing a smart contract stored as part of the digital ledger data; and providing access to the image upon the smart contract confirming authorization to access the image.

According to one embodiment of the method, the method further includes providing purchase or licensing options before executing the smart contract; and receiving, from a user, authorization for a payment for a purchase or license of the image.

According to one embodiment of the method, the payment is received using digital currency.

According to one embodiment of the method, the payment is received using bitcoin.

According to one embodiment of the method, the payment is received using Ether.

According to one embodiment of the disclosure, a non-transitory computer readable medium storing executable logic that performs the methods disclosed herein.

### BRIEF DESCRIPTION OF THE DRAWINGS

FIG. 1 is a schematic block diagram of an electronic device having a camera module that generates and transmits digital ledger information to a digital ledger network and includes a link to the digital ledger information as part of the image file at creation of the image file, the electronic device is shown as part of a system.

FIG. 2 is a flow diagram of a representative method of generating and transmitting digital ledger information associated with an image file.

FIG. 3 is a schematic block diagram representing an image file's relationship with the digital ledger data.

FIG. 4 is a flow diagram of a representative method of interacting with digital ledger information to receive access to an image file.

### DETAILED DESCRIPTION OF EMBODIMENTS

### Introduction

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below, in conjunction with the appended figures, are various embodiments of systems and methods for creating an image file with digital ledger information and subsequent use of the image file.

### System Architecture

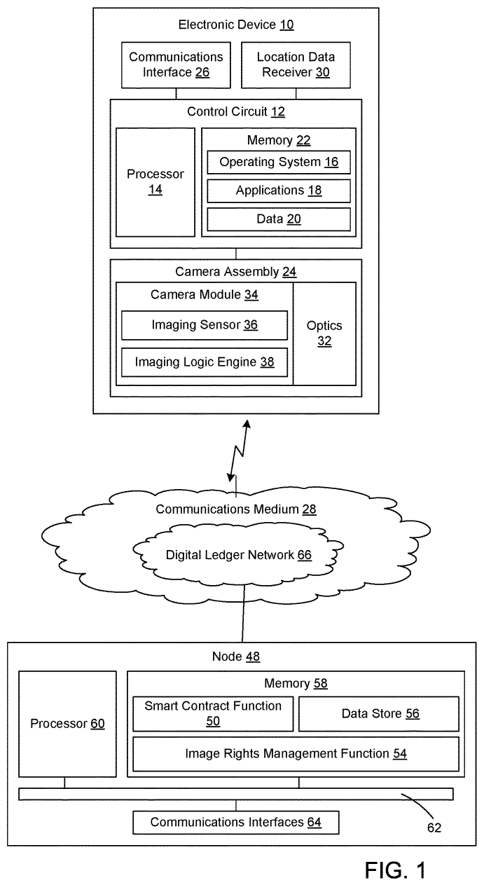

FIG. 1 is a schematic diagram of an exemplary system for implementing the disclosed techniques. It will be appreciated that the illustrated system is representative and other systems may be used to implement the disclosed techniques.

The system includes an electronic device 10. The electronic device 10 of the illustrated embodiment is a camera. The camera may be a stand-alone device. In other embodiments, the camera functionality of the electronic device 10 may be made part of device that has functions other than just generating image files. As such, the electronic device may be, but is not limited to, a mobile radiotelephone (a “smartphone”), a user equipment or UE as contemplated under 3GPP standards, a tablet computing device, a computer, a device that uses machine-type communications, machine-to-machine (M2M) communications or device-to-device (D2D) communication (e.g., a sensor, a machine controller, an appliance, etc.), a media player, a gaming device or console, a security camera, a camera that is part of an vehicle, a camera that is part of a drone, etc.

Also, while the disclosed techniques are described in connection with the creation of still images, the disclosed techniques may be applied to video. For instance, a link to digital ledger data can be included in metadata of video or selected frames of video using the disclosed techniques.

The electronic device 10 is configured to carry out associated logical functions that are described herein. Referring to the exemplary embodiment of a camera, the electronic device 10 includes a control circuit 12 that is responsible for overall operation of the electronic device 10. In embodiments where the electronic device 10 carries out non-camera functions (e.g., as in the case of a smartphone), the control circuit 12 may carry out the non-camera functions of the electronic device 10.

The control circuit 12 includes a processor 14 that executes code, such as an operating system 16 and various applications 18, to carry out various functions of the electronic device 10. Logical functions and/or hardware of the electronic device 10 may be implemented in other manners depending on the nature and configuration of the electronic device 10. Therefore, the illustrated and described approaches are just examples and other approaches may be used including, but not limited to, the control circuit 12 being implemented as, or including, hardware (e.g., a microprocessor, microcontroller, central processing unit (CPU), etc.) or a combination of hardware and software (e.g., a system-on-chip (SoC), an application-specific integrated circuit (ASIC), field programmable gate array (FPGA), etc.).

The operating system 16, the applications 18, and stored data 20 are stored on a memory 22. The stored data 20 may include, but is not limited to, data associated with the operating system 16, data associated with the applications 18, and user files such as image files output by a camera assembly 24. The generation of image files by the camera assembly 24 will be described in greater detail below.

The memory 22 may be, for example, one or more of a buffer, a flash memory, a hard drive, a removable media, a volatile memory, a non-volatile memory, a random access memory (RAM), or other suitable device. In a typical arrangement, the memory 22 includes a non-volatile (persistent) memory for long term data storage and a volatile memory that functions as system memory for the control circuit 12. The memory 22 is considered a non-transitory computer readable medium.

In one embodiment, the electronic device 10 includes a communications interface 26 (e.g., communications circuitry) that enables the electronic device 10 to establish various wireless communication connections. In the exemplary embodiment, the communications circuitry includes a radio circuit. The radio circuit includes one or more radio frequency transceivers and at least one antenna assembly. Wired communications interfaces 26 also may be present. The communications interface 26 is operational to conduct communications with other devices over a communications medium 28 that may include one or more of a local device connected to the electronic device 10, a cellular radio network, a local area network (e.g., WiFi network), the Internet, etc. A digital ledger network 66 can be part of the communication medium 28.

The electronic device 10 may include a variety of other components. For instance, the electronic device 10 may include a display (not shown) for displaying visual information to a user. The display may be coupled to the control circuit 12 by a video circuit that converts video data to a video signal used to drive the display. The video circuit may include any appropriate buffers, decoders, video data processors, and so forth.

The electronic device 10 may include one or more user inputs (not shown) for receiving user input for controlling operation of the electronic device 10. Exemplary user inputs include, but are not limited to, a touch sensitive input that overlays or is part of the display for touch screen functionality, and one or more buttons. Other types of data inputs may be present, such as one or more motion sensors (e.g., gyro sensor(s), accelerometer(s), etc.).

The electronic device 10 may further include a sound circuit (not shown) for processing audio signals. Coupled to the sound circuit are a speaker and a microphone that enable audio operations that are carried out with the electronic device 10 (e.g., conduct telephone calls, output sound, capture audio, etc.). The sound circuit may include any appropriate buffers, encoders, decoders, amplifiers, and so forth.

The electronic device 10 may further include a power supply unit (not shown) that includes a rechargeable battery. The power supply unit supplies operational power from the battery to the various components of the electronic device in the absence of a connection from the electronic device 10 to an external power source.

The electronic device 10 may include one or more input/output (I/O) connectors (not shown) in the form electrical connectors for operatively connecting to another device (e.g., a computer) or an accessory via a cable, or for receiving power from an external power supply.

The electronic device 10 also may include a subscriber identity module (SIM) card slot (not shown) in which a SIM card (not shown) is received. The slot includes any appropriate connectors and interface hardware to establish an operative connection between the electronic device 10 and the SIM card.

As another example, a position data receiver 30, such as a global positioning system (GPS) receiver or global navigation satellite system (GNSS) receiver, may be present to assist in determining the location of the electronic device 10.

Turning to the camera assembly 24, the camera assembly includes optics 32 and an electronics module, also referred to as a camera module 34. The optics 32 may include any appropriate elements to direct light from a scene to be imaged to a sensor component of the camera module 34. The optical elements may include one or more of a filter, a polarizer, a lens or lenses, a prism, etc. The optics 32 may be capable of performing optical zoom and/or optical focusing.

The camera module 34 includes an imaging sensor 36, such as a charged coupled device (CCD) sensor. The imaging sensor 36 outputs raw sensor data representative of the scene. The camera module 34 also includes an imaging logic engine 38. The imaging logic engine 38 executes logic (e.g., code or executable instructions) that processes the raw sensor data and outputs image data from the camera module 34 in the form of an image file. The imaging logic engine 38 may be implemented with an image processor and associated executable logic, or any other appropriate combination of hardware and logic components (e.g., microprocessor, microcontroller, CPU, ASIC, SoC, FPGA, etc.). As will be described, the imaging logic engine 38 and/or the control circuit 12 generates digital ledger data (e.g. blockchain data), transmits the digital ledger data to a digital ledger network, and incorporates a link to the digital ledger data in the metadata associated with the image. It should be appreciated that the metadata can include any known standard including, but not limited to, XMP or Exif. In a typical arrangement, the camera module 34 may include buffers for temporary data storage and manipulation, but does not include any long-term or persistent data storage capabilities.

### Image File Generation and Receipt

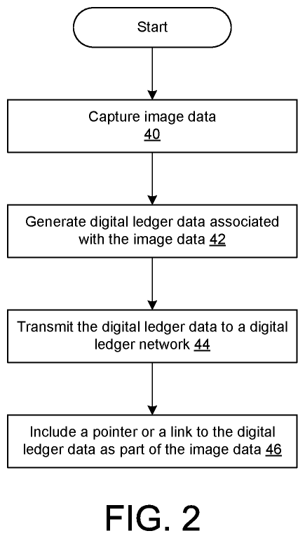

With additional reference to FIG. 2, shown is an exemplary flow diagram representing steps that may be carried out by computer program code installed on the electronic device 10 to generate an image file, generate and transmit digital ledger data pertaining to the image file, and including data within the image file linking to the digital ledger data. FIG. 2 illustrates an exemplary process flow and, although illustrated in a logical progression, the illustrated blocks may be carried out in other orders and/or with concurrence between two or more blocks. Therefore, the illustrated flow diagram may be altered (including omitting steps) and/or may be implemented in an object-oriented manner or in a state-oriented manner.

The logical flow may start in block 40. In block 40, the camera assembly 24 of the electronic device 10 captures image data. Once this image data is captured, an application on the electronic device 10 generates digital ledger data associated with the image data that includes conditions for accessing or licensing the image, and a manner for submitting payment to the owner of the image. Included in the digital ledger data is image rights management information for the image. The image rights management information includes information pertaining to a purchase and/or license of the photo. For example, this information can include a price for a purchase, or a price for a license. The image rights management information also includes identity information of the owner of the image or information identifying an account belonging to the owner of the image. It should be appreciated that this information remains encrypted such that the owner's identity information can remain anonymous to any other user interacting with the digital ledger data. Digital ledgers are distributed databases that are consensually shared and synchronized across multiple sites, and are generally considered incorruptible. Digital ledger technology is commonly used to track a series of transactions, events or data related to an item such as cryptocurrency. In the embodiments described herein, the item is the image file. Exemplary digital ledgers include, but are not limited to, blockchain and Ethereum.

Also included in the digital ledger data is a smart contract. A smart contract (also known as a self-executing contract) is a portion of computer code that is stored, replicated, and supervised on the digital ledger network 66. The smart contract operates by conditioning an action on certain inputs. For example, the smart contract will automatically provide the image to a user as soon as the user authorizes a payment required by the smart contract. In certain embodiments, the smart contract can transfer the image file directly to a user's device through a software program, or the smart contract can provide the image file to a user through an e-mail address associated with the user. In other embodiments, the image is already available to users on the internet, a digital marketplace, or exchange (e.g. the image file is an unprotected, unsecured image file already available for download). In these embodiments, the smart contract can provide an acknowledgement or confirmation of purchased rights, ownership, or licenses to a purchasing user. The acknowledgement or confirmation can be in the form of an e-mail sent to an e-mail address assigned to the user, or it can be in the form of an order/transaction history or image rights inventory (e.g. a digital “wallet”, or digital photo album) viewable on a ledger software program local to the user.

In block 44, the electronic device 10 transmits the digital ledger data to the digital ledger network 66. A hash is placed into the digital ledger on the digital ledger network 66. The hash identifies the image and also identifies the owner of the image. In an embodiment, the hash is a hash of the image data.

In block 46, the electronic device 10 includes a pointer or a link to the image's digital ledger data on the digital ledger network 66 as part of the image data. For example, this pointer or link is included as part of the image's metadata.

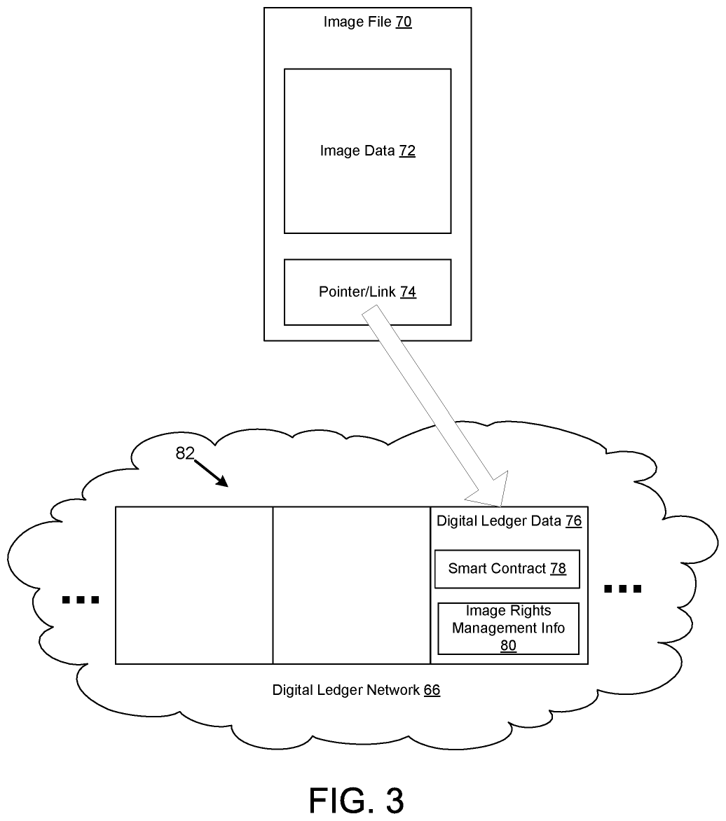

Turning now to FIG. 3, a system architecture is shown that displays the relationship between the image file 70 and the digital ledger data 76. When an image is captured using the electronic device 10 as in block 40 of FIG. 2, the electronic device 10 generates image data 72 and digital ledger data 76 containing one or more smart contracts 78 and image rights management info 80. The electronic device 10 transmits the digital ledger data 76 to a digital ledger network 66. The corresponding hash is added to the digital ledger 82 located on the digital ledger network. After the digital ledger data 76 is transmitted to the digital ledger network 66, the electronic device 10 generates a pointer or a link 74 that directs a user to the digital ledger data 76. The pointer or link 74 can be in the form of an IP address or a URL specifying a location in the digital ledger network 66, or it can be a digital ledger network address specific to the digital ledger network 66. For example, the pointer or link 74 can be a blockchain address such as a Bitcoin address or Ethereum address, among others. The electronic device 10 includes the pointer or link 74 with the image data 72 as part of the image file 70. The image file 70 can then be distributed (e.g. on the internet) while retaining its pointer/link 74 data, thus enabling a user to view the image file 70, view the image's rights and licenses available for purchase, and make a payment to the owner for use of the image file, as further described.

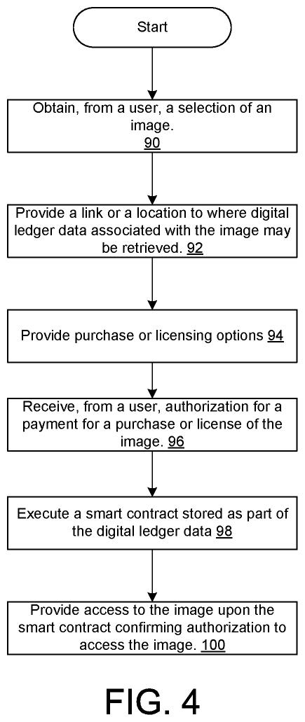

Turning now to FIG. 4, a method is displayed where the smart contract generated in the method of FIG. 2 provides image access or rights to another electronic device of a user. In block 90, a user selects an image with a device such as a mobile device, computer, or any other network connected device. The user input is received and the image is rendered or displayed. In block 92, the device navigates to the image's digital ledger data based on the pointer or link included with the image data. In certain embodiments, the link is displayed to the user. In block 94, the device reads the digital ledger data and displays purchase or licensing options available to the user.

In block 96, the digital ledger network receives, from a user, authorization for a payment for a purchase or license of the image. This payment can be made using standard currency or using digital crypto-currency such as Bitcoin or Ether. In block 98, the digital ledger network executes the smart contract stored as part of the image's digital ledger data. In block 100, the smart contract provides access to the image upon the smart contract confirming authorization to access the image. Once payment is authorized by the user and acknowledged within the digital ledger network 66, the smart contract transmits the image itself or an acknowledgment of purchased rights associated with the image to the user's device. As previously discussed, the smart contract can transfer the image file directly to a user's device through a software program, or the smart contract can provide the image file to a user through an e-mail address associated with the user. In other embodiments, the image is already available to users on the internet, a digital marketplace, or exchange (e.g. the image file is an unprotected, unsecured image file already available for download). In these embodiments, the smart contract can provide an acknowledgement or confirmation of purchased rights, ownership, or licenses to a purchasing user. The acknowledgement or confirmation can be in the form of an e-mail sent to an e-mail address assigned to the user, or it can be in the form of an order/transaction history or image rights inventory (e.g. a digital “wallet”, or digital photo album) viewable on a ledger software program local to the user. Details and records of this transaction can be added to the digital ledger.

### Practical Application

Digital ledgers (e.g. blockchain) provide an inherent level of security to data associated with the digital ledger. The specific operation of digital ledgers (also known as distributed ledgers) will not be described in this disclosure, but their attributes may be used for various functions in connection with the digital ledger data transmitted to the digital ledger network 66 in block 44 of the flow diagram of FIG. 2. Thus, the data contained in the digital ledger data may be used in a standardized way across multiple platforms and devices to carry out various functions. As an example, when a user accesses the digital ledger data by following a link in the image file data, the user can interface with the digital ledger data. Using this information, a user may communicate back to the electronic device 10 from which the image file originated or communicate with an account owned by the user of the electronic device 10 from which the image file originated.

Many of these functions may take place in connection with one or more nodes 48 located on the digital ledger network 66, and accessible though the communications medium 28. Various functions will be described in connection with the node 48 illustrated in FIG. 1. It should be appreciated that different functions may be handled by different nodes and/or distributed across computing platforms located on the digital ledger network 66.

The node 48 may be implemented as a computer-based system that is capable of executing computer applications (e.g., software programs). Exemplary applications include a smart contract function 50, and an image rights management function 54. The applications, when executed, carry functions of the node 48 that are described herein. The applications and a data store 56 may be stored on a non-transitory computer readable medium, such as a memory 58. The data store 24 may be used to store various information sets used to carry out the functions described in this disclosure. The memory 58 may be, for example, a magnetic, optical or electronic storage device (e.g., hard disk, optical disk, flash memory, etc.), and may comprise several devices, including volatile and non-volatile memory components. Accordingly, the memory 58 may include, for example, random access memory (RAM) for acting as system memory, read-only memory (ROM), solid-state drives, hard disks, optical disks (e.g., CDs and DVDs), tapes, flash devices and/or other memory components, plus associated drives, players and/or readers for the memory devices.

To execute logical operations, the node 48 may include one or more processors 60 used to execute instructions that carry out logic routines. The processor 60 and the memory 58 may be coupled using a local interface 62. The local interface 62 may be, for example, a data bus with accompanying control bus, a network, or other subsystem.

The node 48 may have various input/output (I/O) interfaces for operatively connecting to various peripheral devices. The node 48 also may have one or more communications interfaces 64. The communications interface 64 may include for example, a modem and/or a network interface card. The communications interface 64 enables the node 48 to send and receive data to and from other computing devices via the communications medium 28. In one embodiment, the node 48 may be configured to host the described services for a plurality of electronic devices, including the electronic device 10. Some of the services may be access by user devices or systems that are not illustrated. However, the configuration and operation of such devices will be understood to the person of ordinary skill in the art.

The smart contract function 50 may be used to run a portion of computer code to analyze various conditions and perform an action based on the conditions being satisfied. The smart contract function 50 may work on an “if-then” premise. If all conditions required by the smart contract are satisfied, then the node 48 executes a predefined action. For example, a smart contract may require a specific user payment for access to a full resolution version of an image. When a user authorizes payment to satisfy the condition of the smart contract, the smart contract executes and provides access to the full resolution image to the user.

The image rights management function 54 may be used to facilitate communication back to the electronic device 10 from which the image file originated or to communicate with an account owned by the user of the electronic device 10 from which the image file originated. In one embodiment, use of the image file in the news media or for other purposes may be subject to license terms or payment requirements. From the digital ledger data associated with the image file, the image rights management function 54 may determine the license terms or payment requirements associated with the image file. Then, if appropriate, payment to an appropriate party or account may be made. The appropriate party need not be a person or entity associate with the electronic device 10 that captured the image. Rather, data from an appropriate block of a digital ledger may be used to determine the appropriate party or account or payment. The authenticity of the overall digital ledger may be confirmed to authenticate the ownership information associated with the image. In this way, a buyer or licensee of the rights in the image content may validate the party selling or licensing the right image content.

In an exemplary embodiment, a first user captures an image using an electronic device 10. A software application in the electronic device 10 automatically generates and associates digital ledger data 76 including a smart contract 78 with the image file 70. The digital ledger data also includes owner information and available rights, also known as image rights management info 80. The software application on the electronic device 10 can include settings that allow the first user to configure the digital ledger data generation process. For example, the first user can specify available rights to the image and associated prices for access to the image. In this manner, the first user can pre-configure the application so that the electronic device 10 automatically generates and transmits the digital ledger data 76 for each image captured, without any need for further user interface.

After the digital ledger data is generated, the electronic device 10 transmits the digital ledger data 76 to a digital ledger network 66. The electronic device 10 then includes a pointer or a link 74 as part of the image file 70 (e.g. metadata). After recording the digital ledger data 76 to the digital ledger network 66, the image file 70 can be published or shared. For example, the image file 70 can be published as part of a digital marketplace or media exchange site. A second user can browse the digital marketplace or media exchange site with a network connected device (e.g. mobile device, computer, etc.) and discover the image file 70. The second user can then select the image file 70. Selecting the image with the network connected device causes the network connected device to navigate to the digital ledger data 76 based on the pointer or link 74. The second user can access the digital ledger data 76 to view the available rights and corresponding prices for access. If the second user decides to purchase rights to the image or otherwise gain access to the image file 70, the second user uses the network connected device to authorize payment. When the second user authorizes payment, the smart contract 78 included in the digital ledger data 76 verifies the payment and provides the second user with access to the image. In some embodiments, the smart contract 78 provides an authorization for the second user to use the image according to the purchased rights or license. In further embodiments, rather than requiring a payment, the smart contract can provide a user with access or authorization to use an image based on the user accepting terms of use for the image.

In a further embodiment, the image displayed on the digital marketplace or media exchange site is a low-resolution version of the image or a watermarked version of the image. When the second user authorizes payment, the smart contract 78 executes a function to provide the second user access to a full-resolution and/or non-watermarked version of the image.

In an additional embodiment, the electronic device 10 can store image files locally. The electronic device 10 can upload the image to a server or online storage. At this point, an application on the server or online storage can generate the ledger data 76, transmit the digital ledger data 76 to the digital ledger network 66, and include a pointer or link 74 as part of the image file.

### Conclusion

Although certain embodiments have been shown and described, it is understood that equivalents and modifications falling within the scope of the appended claims will occur to others who are skilled in the art upon the reading and understanding of this specification.

1. An electronic device, comprising:
a camera assembly configured to capture an image and to process the image to create an image file;
a communications interface; and
a processor configured to:
generate digital ledger data comprising a smart contract providing rights to use or access the image based on a condition being satisfied, and image rights management information;
transmit the digital ledger data using the communications interface, to a digital ledger network; and
embed a pointer or link as a portion of data included within the image file, wherein the pointer or link provides a location to access the digital ledger data.

2. The electronic device of claim 1, wherein the smart contract is a portion of computer code.

3. The electronic device of claim 1, wherein the image rights management information comprises an identifier of an owner of the image file.

4. The electronic device of claim 1, wherein the image rights management information comprises an identifier of an account associated with an owner of the image file.

5. The electronic device of claim 1, wherein the image rights management information comprises available rights and prices associated with a purchase of the available rights.

6. A method of tracking ownership information for an image, comprising:
capturing image data using a camera assembly;
processing the image data to generate an image file;
generating digital ledger data comprising a smart contract, and image rights management information associated with the image data;
transmitting the digital ledger data to a digital ledger network;
generating a pointer or a link to the digital ledger data; and
embedding the pointer or the link in the image file.

7. The method of claim 6, further comprising:
receiving payment from a user based on the user purchasing a right to use the image, and satisfying a condition of the smart contract.

8. The method of claim 6, wherein the smart contract is a portion of code that provides rights to use the image, or access to the image, based on a receipt of payment.

9. The method of claim 6, wherein the image rights management information comprises an identifier of an owner of the image file.

10. The method of claim 6, wherein the image rights management information comprises an identifier of an account associated with an owner of the image file.

11. The method of claim 6, wherein the image rights management information comprises available rights and prices associated with a purchase of the available rights.

12. A method of providing a right to use an image, comprising:
obtaining, from a user, a selection of an image;
providing a link or a location to where digital ledger data associated with the image may be retrieved;
executing a smart contract stored as part of the digital ledger data; and
providing access to the image upon the smart contract confirming authorization to access the image.

13. The method of claim 12, further comprising:
providing purchase or licensing options before executing the smart contract; and
receiving, from a user, authorization for a payment for a purchase or license of the image.

14. The method of claim 13, wherein the payment is received using digital currency.

15. The method of claim 13, wherein the payment is received using bitcoin.

16. The method of claim 13, wherein the payment is received using Ether.

17. A non-transitory computer readable medium storing executable logic that, when executed by a processor, performs the method of claim 6.
